(19) United States
(12) Patent Application Publication
(10) Pub. No.: US 2015/0020766 A1
(43) Pub. Date: Jan. 22, 2015

(54) PRECHAMBER DEVICE FOR AN INTERNAL COMBUSTION ENGINE

(71) Applicant: CUMMINGS INC., Columbus, IN (US)

(72) Inventors: Leon A. LaPointe, Columbus, IN (US); Premjee Sasidharan, Columbus, IN (US)

(21) Appl. No.: 13/946,451

(22) Filed: Jul. 19, 2013

(51) Int. Cl. F02B 19/16

(52) U.S. Cl. CPC F02B 19/16
USPC 123/285

(57) ABSTRACT

The disclosure is directed to an internal combustion engine having an improved prechamber device. The prechamber device includes features that provide improved mixing of fuel and air, specifically, a plurality of ribs positioned in a cavity of the prechamber device. The improved mixing of fuel and air yields improved uniformity of combustion in an associated combustion chamber.

### TECHNICAL FIELD

This disclosure relates to a prechamber device for an internal combustion engine.

### BACKGROUND

Some spark ignition engines use a prechamber device (either fueled or passive) to increase the ignition energy imparted to the charge in the main combustion chamber. During operation of these engines, gases will flow both into and out from the prechamber device depending on the pressure differential between the prechamber device inner cavity and the main combustion chamber. At some point during the compression stroke, gas, including both fuel and air, will flow into the prechamber device from the main chamber. A fuel-fed prechamber device will introduce additional fuel into the prechamber device to enrich the prechamber device contents prior to ignition; a passive prechamber device will not. After ignition, the pressure inside the prechamber device will rise above the main combustion chamber and the contents of the prechamber device, including burned and unburned fuel, will be injected into the main combustion chamber to initiate the combustion process of fuel and air in the main combustion chamber.

### SUMMARY

This disclosure provides a prechamber device for an internal combustion engine, comprising a prechamber body and a plurality of rib portions. The prechamber body has a first end, a second end a spaced longitudinal distance from the first end, a prechamber cavity, and an interior surface forming the prechamber cavity. The interior surface extends circumferentially around the prechamber cavity from the first end to the second end. The plurality of rib portions is positioned on the interior surface and spaced circumferentially around the interior surface. Each of the plurality of rib portions extends from the interior surface into the prechamber cavity and extends along a direction that is from the first end to the second end.

This disclosure also provides a prechamber device for an internal combustion engine, comprising an interior surface and a plurality of rib portions formed on the interior surface. The interior surface forms a cavity and includes a first, circumferentially extending curvilinear portion and a second, cylindrical portion. The first, circumferentially extending curvilinear portion includes a proximate end and a distal end. The distal end is positioned between the curvilinear portion and the cylindrical portion. The plurality of rib portions is positioned on the interior surface in the curvilinear portion, each rib portion extending from the interior surface into the cavity, and extending from the proximate end toward the distal end.

Advantages and features of the embodiments of this disclosure will become more apparent from the following detailed description of exemplary embodiments when viewed in conjunction with the accompanying drawings.

### BRIEF DESCRIPTION OF THE DRAWINGS

FIG. 1 is a partial sectional view of a portion of an internal combustion engine incorporating an exemplary embodiment prechamber device of the present disclosure.

FIG. 2 is a view of a portion of FIG. 1 along the lines 2-2.

FIG. 3 is a cross sectional view of the prechamber device of FIG. 1 along the lines 3-3.

FIG. 4 is a cross sectional view of a conventional prechamber device showing stylized fluid flow.

FIG. 5 is a cross sectional view of the prechamber device of FIG. 1 similar to the view of FIG. 3, with the addition of stylized fluid flow.

FIG. 6 is a partial sectional view of a prechamber device in accordance with a second exemplary embodiment of the present disclosure.

### DETAILED DESCRIPTION

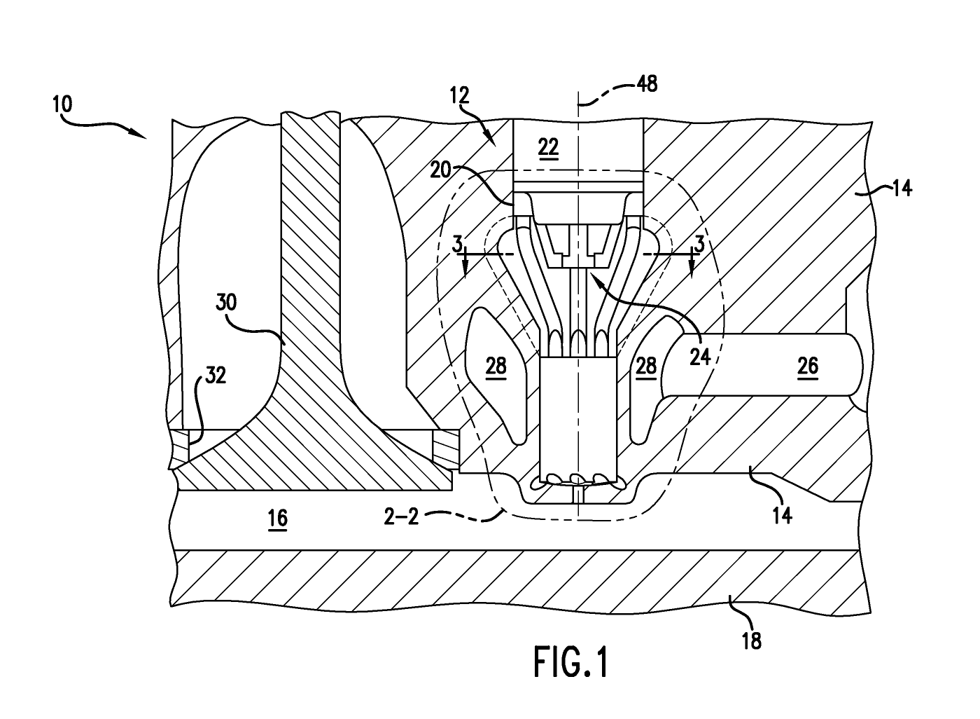

Referring now to FIG. 1, the present disclosure is directed to an internal combustion engine, a portion of which is shown in a cutaway cross sectional view and generally indicated at 10, having an improved prechamber device 12. Prechamber device 12 includes features that provide improved mixing of fuel and air that yields more uniform combustion of fuel and air as compared to previous prechamber devices.

Internal combustion engine 10 includes an engine body that further includes a cylinder head 14 and an engine block (not shown). The engine block includes one or more cylinders, with a piston 18 mounted for reciprocal movement in each cylinder. The engine body includes a combustion chamber 16 that is formed between cylinder head 14 and piston 18 in a portion of each cylinder that extends from an end of each piston 18 to cylinder head 14. Further included in the engine body is an ignition bore 20 in which is positioned a combustion igniter 22. Combustion igniter 22 includes an igniter element 24 and in the exemplary embodiment may be a spark plug. Prechamber device 12 is positioned between combustion igniter 22 and combustion chamber 16.

Cylinder head 14 may further include one or more coolant passages 26 that provide cooling fluid to coolant gallery 28 proximate to prechamber device 12. Cooling fluid passages may also be proximate to combustion igniter 22. The engine body may include other elements in proximity to combustion chamber 16. For example, one or more valves 30 may provide entry and exit points for air and/or fuel to enter combustion chamber 16 and for exhaust gases to exit combustion chamber 16. A valve seat 32 may be associated with each valve 30 to provide a location for valve 30 to rest when closed.

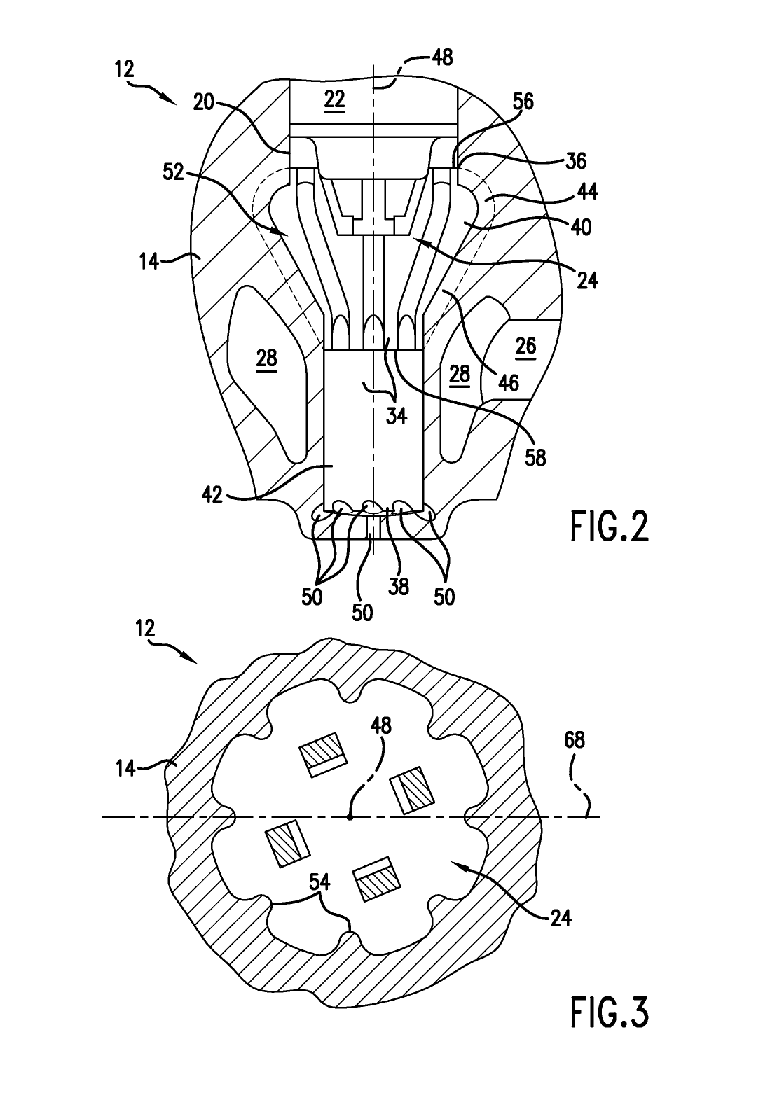

Referring to FIGS. 1-3, prechamber device 12 in accordance with an exemplary embodiment of the present disclosure is shown. Prechamber device 12 includes a prechamber body, which in the exemplary embodiment is formed as a part of cylinder head 14, a longitudinal axis 48, and an interior surface 34 that extends longitudinally from a first or proximate end 36 of prechamber device 12 to a second or distal end 38, which is a spaced longitudinal distance from first end 36, of prechamber device 12. First or proximate end 36 receives igniter element 24 of combustion igniter 22 and second or distal end 38 is in fluid communication with combustion chamber 16. By extension, first end 36 is a spaced distance away from combustion chamber 16 and second end 38 is a spaced distance away from combustion igniter 22. Additionally, second end 38 is positioned between first end 36 and combustion chamber 16. In another embodiment, the prechamber body may also be formed as a separate component or assembly and positioned in cylinder head 14. Interior surface 34 forms a prechamber cavity 52 that includes an upper portion 40 and a lower portion 42. Upper portion 40 has a curvilinear shape when viewed in cross section that includes a plurality of geometric shapes. Upper portion 40 includes an upper portion proximate end 56, an upper portion distal end 58, a transition portion 44, which may include an arc having a circular shape, and a main portion 46, which may have a conical shape when viewed in cross section, therefore having an increasing cross section with longitudinal distance from distal end 58 toward proximate end 56 and toward combustion igniter 22. Transition portion 44 extends from ignition bore 20 to main portion 46. Transition portion 44 has a larger maximum diameter than ignition bore 20 and serves to provide an entry area for fuel if fuel is injected into proximate end 36 of prechamber device 12. Main portion 46 provides the principal mixing region or area for fuel and air in prechamber device 12. Upper portion proximate end 56 may coincide with prechamber cavity proximate end 36. Upper portion distal end 58 is positioned between upper portion 40 and lower portion 42. Lower portion 42 is generally cylindrical in shape, with variations due to the draft necessary for casting and radii at locations where lower portion 42 interfaces with other features, such as main portion 46 and distal end 38. Prechamber device 12 further includes a plurality of prechamber passages 50 that extend through prechamber body 14 to permit fluid communication between second end 38 of lower portion 42 of prechamber cavity 52 and combustion chamber 16. Because flow may be in to and out from prechamber cavity 52 by way of prechamber passages 50, prechamber passages 50 may therefore be consider inlet/outlet passages.

Prechamber device 12 also includes a plurality of ribs, protrusions, or humps 54 that extend from interior surface 34 toward longitudinal axis 48. In an exemplary embodiment, ribs 54 extend in a direction that is generally along longitudinal axis 48, which is also generally in a direction that is from first end 36 to second end 38. In an exemplary embodiment, each rib 54 extends in a longitudinal direction and shares a common plane with central axis 48 of prechamber cavity 52, such as a common plane 68 shown in FIG. 3. Ribs 54 follow the contour of prechamber cavity 52, particularly the contour of upper portion 40. In one embodiment, ribs 54 may extend a longitudinal distance that is less than a longitudinal length of upper portion 40, and may thus leave lower portion 42 devoid of ribs. In another embodiment, ribs 54 may extend from upper portion proximate end 56 to upper portion distal end 58, leaving lower portion 42 devoid of ribs. In yet another embodiment, described further hereinbelow, ribs 54 may extend into lower portion 42. As best seen in FIG. 3, in the exemplary embodiment ribs 54 have a curvilinear shape when viewed in cross-section. Ribs 54 may be spaced uniformly about the circumference of prechamber cavity 52, or ribs 54 may be spaced asymmetrically about the circumference of prechamber cavity 52. In an exemplary embodiment, each rib 54 may extend or subtend approximately 20 degrees in the circumferential direction and may extend in the range of about 2% to 20% of the maximum diameter of prechamber cavity 52. The number of ribs 54 depends on the diameter of prechamber cavity 52 and the ability to form ribs 54. While the exemplary embodiment shows eight ribs 54, other embodiments may have more ribs or fewer ribs. Ribs 54 may be formed integrally with prechamber device 12, e.g., as part of cylinder head 14, or they may be formed separate from prechamber device 12 and positioned in prechamber device 12.

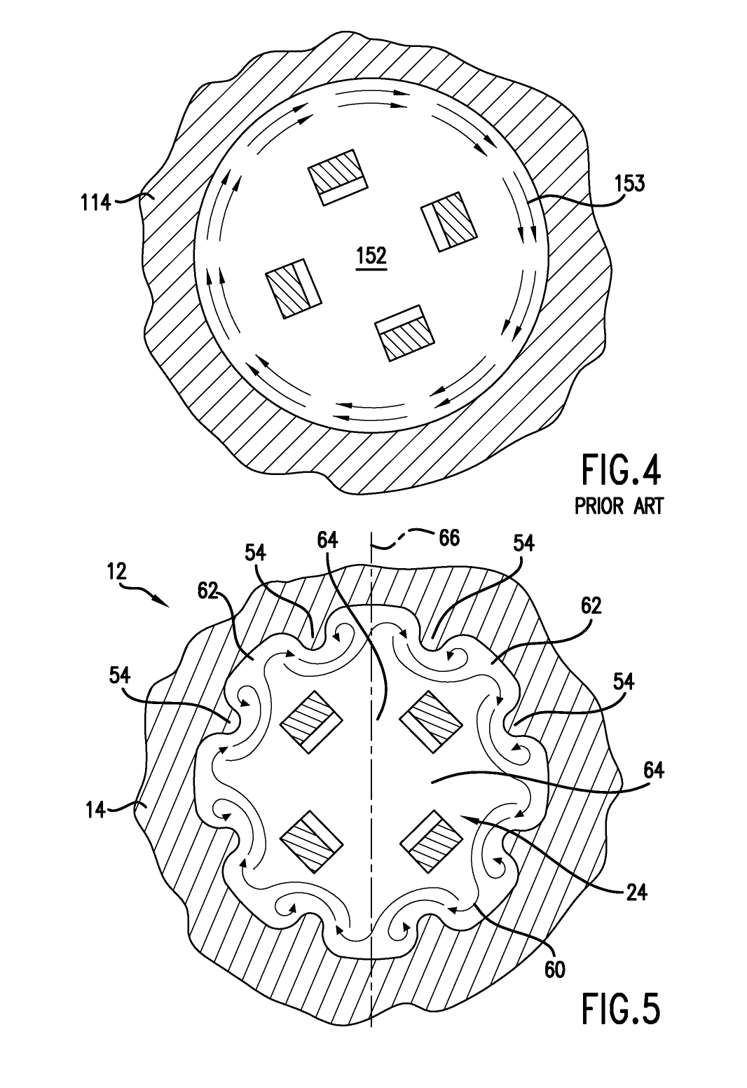

During operation of engine 10, highly pressurized fuel may flow into prechamber cavity 52 from proximate end 36, where the fuel mixes with air that enters prechamber cavity 52 from prechamber passages 50. Alternatively, a mixture of fuel and air may flow from combustion chamber 16 through prechamber passages 50 into prechamber cavity 52 when compression of the fuel and air in the combustion chamber rises above the pressure in prechamber cavity 52. In a conventional prechamber cavity, for example prechamber cavity 152 positioned in a cylinder head 114 and shown in FIG. 4, the orientation of prechamber passages 50 or the orientation of fuel inlet passages that provide fuel to proximate end 36 causes the mixture of fuel and air to swirl or rotate about longitudinal axis 48 as the fuel and air flow into and out from prechamber cavity 152. As can be seen in FIG. 4, stylized fluid flow lines 153 flow in a circular motion and any striation or separation between fuel and air may be maintained during flow of fuel and air into and out from prechamber cavity 152. The addition of ribs 54 causes turbulence in the mixture of fuel and air that flows in prechamber cavity 52, as shown by stylized flow lines 60 in FIG. 5. The turbulence caused by the addition of ribs 54 leads to turbulence in regions 62 that are circumferentially between ribs 54, which may be described as micro-turbulence because of the size of mixing regions 62. The turbulence in regions 62 leads to a reversal or intertwining of flow lines, improving mixing of fuel and air as the fuel and air flows in prechamber cavity 52. FIG. 5 also shows that igniter element 24 of combustion igniter 22 includes a plurality of igniter element gaps 64. In an exemplary embodiment, each rib 54 of a pair of adjacent ribs 54 is positioned on either side of a plane 66 that extends through a pair of opposite igniter element gaps 64. Igniter element gaps 64 are ignition zones due to a spark that jumps gap 64. When fuel and air are present in gap 64 and a spark crosses gap 64, a flame kernel is created that propagates through prechamber cavity 52 into combustion chamber 16. Because of the improved mixing of fuel and air caused by ribs 54, the rate of combustion within prechamber cavity 52 is accelerated, and the combustion duration of a bulk lean charge inside combustion chamber 16 is reduced, ultimately improving the efficiency of engine 10.

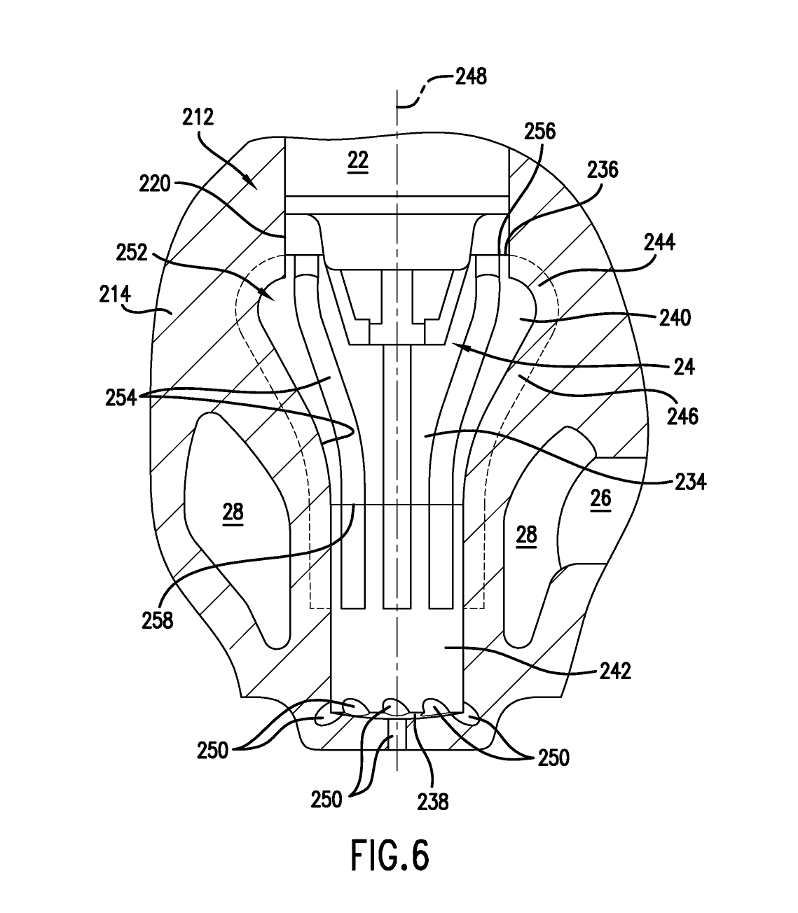

As described hereinabove, ribs 54 may be in a variety of configurations that yield the benefits described hereinabove. A prechamber device 212 positioned in a cylinder head 214 and shown in FIG. 6 shows a second exemplary embodiment of the present disclosure incorporating such a configuration. Prechamber device 212 includes a prechamber body, which in the exemplary embodiment is formed as a part of cylinder head 214, a longitudinal axis 248, and an interior surface 234 that extends longitudinally from a first or proximate end 236 of prechamber device 212 to a second or distal end 238, which is a spaced longitudinal distance from first end 236, of prechamber device 212. In another embodiment, the prechamber body may also be formed as a separate component or assembly and positioned in cylinder head 214. Interior surface 234 forms a prechamber cavity 252 that includes an upper portion 240 and a lower portion 242. Upper portion 240 has a curvilinear shape when viewed in cross section that includes a plurality of geometric shapes. Upper portion 240 includes an upper portion proximate end 256, an upper portion distal end 258, a transition portion 244, which may include an arc having a circular shape, and a main portion 246, which may have a conical shape when viewed in cross section, therefore having an increasing cross section with longitudinal distance from distal end 258 toward proximate end 256 and toward combustion igniter 22. Transition portion 244 extends from an ignition bore 220 located in cylinder head 214 to main portion 246. Transition portion 244 has a larger maximum diameter than ignition bore 220 and serves to provide an entry area for fuel if fuel is injected into proximate end 236 of prechamber device 212. Main portion 246 provides the principal mixing region or area for fuel and air in prechamber device 212. Upper portion proximate end 256 may coincide with prechamber cavity proximate end 236. Upper portion distal end 258 is positioned between upper portion 240 and lower portion 242. Lower portion 242 is generally cylindrical in shape, with variations due to the draft necessary for casting and radii at locations where lower portion 242 interfaces with other features, such as main portion 246 and distal end 238. Prechamber device 212 further includes a plurality of prechamber passages 250 that permit fluid communication between lower portion 242 of prechamber cavity 252 and combustion chamber 16.

Prechamber device 212 also includes a plurality of ribs, protrusions, or humps 254 that extend from interior surface 234 toward longitudinal axis 248. In an exemplary embodiment, ribs 254 extend in a direction that is generally along longitudinal axis 248, which is also generally in a direction that is from first end 236 to second end 238. The longitudinal extent of ribs 254 begins in upper portion 240 and ends in lower portion 242. In this embodiment, ribs 254 extend a longitudinal distance that is longer than a longitudinal length of upper portion 240. The upper or proximate end of ribs 254 may extend to proximate end 236 of upper portion 240, and the lower or distal end of ribs 254 may extend to distal end 238 of prechamber cavity 252. As ribs 254 extend from upper portion 240 into lower portion 242, ribs 254 follow the contour of upper portion 240 and lower portion 242. Ribs 254 have a curvilinear shape when viewed in cross-section. Ribs 254 may be spaced uniformly about the circumference of prechamber cavity 252, or ribs 254 may be spaced asymmetrically about the circumference of prechamber cavity 252. In an exemplary embodiment, each rib 254 may extend approximately 20 degrees in the circumferential direction and may extend in the range of about 2% to 20% of the maximum diameter of prechamber cavity 252. The number of ribs 254 depends on the diameter of prechamber cavity 252 and the ability to form ribs 254. While the exemplary embodiment shows eight ribs 254, other embodiments may have more ribs or fewer ribs. Ribs 254 may be formed integrally with prechamber device 212, e.g., as part of cylinder head 214, or they may be formed separate from prechamber device 212 and positioned in prechamber device 212. The benefit of the configuration of FIG. 6 is that the mixing areas, regions, or volume is increased in comparison to the mixing volume of the configuration of FIGS. 1-3 because of the increased length of ribs 254. However it may require increased manufacturing complexity to position ribs 254 in lower portion 240.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

I/we claim:

1. A prechamber device for an internal combustion engine, comprising:
a prechamber body having a first end, a second end positioned a spaced longitudinal distance from the first end, a prechamber cavity, and an interior surface forming the prechamber cavity, the interior surface extending circumferentially around the prechamber cavity from the first end to the second end; and
a plurality of rib portions positioned on the interior surface and spaced circumferentially around the interior surface, each of the plurality of rib portions extending from the interior surface into the prechamber cavity and extending along a direction that is from the first end to the second end.

2. The prechamber device of claim 1, wherein the rib portions are spaced equally about the circumference of the interior surface.

3. The prechamber device of claim 1, wherein the interior surface includes a curvilinear portion and a cylindrical portion.

4. The prechamber device of claim 3, wherein the ribs extend longitudinally from the curvilinear portion into the cylindrical portion.

5. The prechamber device of claim 3, wherein the curvilinear portion has a longitudinal length and the ribs extend the entire longitudinal length.

6. The prechamber device of claim 3, wherein the ribs are positioned entirely the curvilinear portion.

7. The prechamber device of claim 3, wherein the curvilinear portion includes a conical portion.

8. The prechamber device of claim 1, wherein a combustion igniter having a gap extends into a proximate end of the curvilinear portion.

9. The prechamber device of claim 8, wherein a rib is positioned on each side of the gap.

10. The prechamber device of claim 1, wherein the cavity includes a diameter, and each of the rib portions extends into the cavity a distance that is in the range of 2.5% to 20% of the diameter.

11. The prechamber device of claim 1, further including a plurality of prechamber passages extending between the prechamber cavity and a combustion chamber of the internal combustion engine, wherein the second end is closer to the prechamber passages than the first end.

12. The prechamber device of claim 1, wherein the prechamber cavity includes a longitudinally-extending central axis, and each of the plurality of ribs is positioned in a common plane with the central axis along the entire longitudinal extent of each respective rib.

13. A prechamber device for an internal combustion engine, comprising:
an interior surface forming a cavity, the interior surface including a first, circumferentially extending curvilinear portion and a second, cylindrical portion, the first, circumferentially extending curvilinear portion including a proximate end and a distal end, the distal end positioned between the curvilinear portion and the cylindrical portion; and
a plurality of rib portions positioned on the interior surface in the curvilinear portion, each rib portion extending from the interior surface into the cavity, and extending from the proximate end toward the distal end.

14. The prechamber device of claim 13, wherein the rib portions are spaced equally about the circumference of the interior surface.

15. The prechamber device of claim 13, wherein the ribs extend longitudinally from the curvilinear portion into the cylindrical portion.

16. The prechamber device of claim 13, wherein the curvilinear portion has a longitudinal length and the ribs extend the entire longitudinal length.

17. The prechamber device of claim 13, wherein the curvilinear portion includes a conical portion.

18. The prechamber device of claim 13, wherein the cavity includes a diameter, and each of the rib portions extends into the cavity a distance that is in the range of 2.5% to 20% of the diameter.

19. The prechamber device of claim 13, further including a plurality of prechamber passages extending between the prechamber cavity and a combustion chamber of the internal combustion engine, wherein the distal end is closer to the prechamber passages than the proximate end.

20. The prechamber device of claim 13, wherein the prechamber cavity includes a longitudinally-extending central axis, and each of the plurality of ribs is positioned in a common plane with the central axis along the entire longitudinal extent of each respective rib.
